(19) United States
(12) Patent Application Publication
(10) Pub. No.: US 2025/0251622 A1
(43) Pub. Date: Aug. 7, 2025

(54) ELECTRONICALLY CONTROLLED VIEWING ANGLE SWITCHING PANEL AND DISPLAY DEVICE

(71) Applicant: Coretronic Corporation, Hsin-Chu (TW)

(72) Inventors: Wen-Chang Wen, Hsin-Chu (TW); Ching-Tai Tseng, Hsin-Chu (TW); Chung-Yang Fang, Hsin-Chu (TW)

(73) Assignee: Coretronic Corporation, Hsin-Chu (TW)

(21) Appl. No.: 19/015,526

(22) Filed: Jan. 9, 2025

(30) Foreign Application Priority Data
Feb. 1, 2024 (CN) 202410140918.X

(51) Int. Cl. G02F 1/13; G02F 1/1335; G02F 1/13357

(52) U.S. Cl. CPC G02F 1/1323; G02F 1/133528; G02F 1/133603; G02F 1/133605

(57) ABSTRACT

An electronically controlled viewing angle switching panel and a display device are provided. The electronically controlled viewing angle switching panel includes a viewing angle adjustment element, a first polarizer, a second polarizer and a support structure. The viewing angle adjustment element includes at least one plastic substrate. The viewing angle adjustment element is located between the first polarizer and the second polarizer. The support structure is connected to at least a part of the second polarizer. The display device includes a light source module, a display panel and the electronically controlled viewing angle switching panel.

### CROSS-REFERENCE TO RELATED APPLICATION

This application claims the priority benefit of China application serial no. 202410140918.X filed on Feb. 1, 2024. The entirety of the above-mentioned patent application is hereby incorporated by reference herein and made a part of this specification.

### BACKGROUND

### Technical Field

The invention relates to an electronic component and an electronic device, and particularly relates to an electronically controlled viewing angle switching panel and a display device.

### Description of Related Art

Along with continuous advancement of display technology, all devices are developing towards trends of small size, thin thickness, and light weight. Therefore, mainstream display devices currently on the market have developed from conventional cathode ray tubes to liquid crystal display devices. In some situations, in order to prevent confidential information from being peeked by others, a louver film is usually placed in front of a display device to filter out large-angle light to achieve an anti-peep effect. When the anti-peep effect is not needed, the louver film may be manually removed and the viewing angle may be switched to a wide angle for everyone to watch. Another current technology is to use an electronically controlled viewing angle switching panel, which does not require manual placement or removal of the viewing angle switching panel, and is convenient.

Generally, a display device using electronically controlled viewing angle switching panel is composed of three main components including a display panel, an electronically controlled viewing angle switching panel, and a backlight module. The backlight module may evenly distribute light at front viewing angles, which allows images on the display panel to be clearly presented. Through switching of the electronically controlled viewing angle switching panel, by controlling whether light in a direction of an anti-peep viewing angle is absorbed by the electronically controlled viewing angle switching panel, screen anti-peep and sharing functions may be further achieved.

However, most of the current electrically controlled viewing angle switching panels use glass substrates, making a thickness and weight of the display device with the electrically controlled viewing angle switching panel larger than that of ordinary display devices. In order to comply with a design trend of thinness and lightness, the substrate must be made of thinner and lighter materials. Although plastic materials meet the needs of the above-mentioned design trend of thinness and lightness, they are not as good as glass in terms of mechanical strength. When the plastic substrates of the electronically controlled viewing angle switching panel are attached with polarizers respectively, the electronically controlled viewing angle switching panel may suffer from some reliability abnormalities under reliability test conditions of high temperature and high humidity or thermal shock.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

In order to achieve one or a portion of or all of the objects or other objects, an embodiment of the invention provides an electronically controlled viewing angle switching panel. The electronically controlled viewing angle switching panel includes a viewing angle adjustment element, a first polarizer, a second polarizer and a support structure. The viewing angle adjustment element includes at least one plastic substrate. The viewing angle adjustment element is located between the first polarizer and the second polarizer. The support structure is connected to at least a part of the second polarizer.

In order to achieve one or a portion of or all of the objects or other objects, an embodiment of the invention provides a display device. The display device includes a light source module, a display panel and an electronically controlled viewing angle switching panel.

Based on the above descriptions, in the electronically controlled viewing angle switching panel and the display device according to an embodiment of the invention, through the arrangement of the support structure, shrinkage of the polarizer may be effectively suppressed under reliability test conditions of high temperature, high humidity and/or thermal shock, thereby preventing deformation of the electronically controlled viewing angle switching panel, and maintaining flatness and structural integrity of the components, and thus ensuring the reliability of the electronically controlled viewing angle switching panel and the display device, so as to reduce the risk of reliability problems.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a display device according to an embodiment of the invention.

FIG. 2A is a schematic structural diagram of the display device in FIG. 1.

FIG. 2B is a schematic diagram of an optical path of a light source module in

FIG. 2A.

FIG. 2C is a schematic structural diagram of a viewing angle adjustment element in FIG. 2A.

FIG. 3A is a schematic structural diagram of a display device according to another embodiment of the invention.

FIG. 3B is an enlarged schematic diagram of a partial area of FIG. 3A.

FIG. 4 is a schematic structural diagram of a display device according to another embodiment of the invention.

FIG. 5A to FIG. 5D are schematic structural diagrams of various light source modules in FIG. 1.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

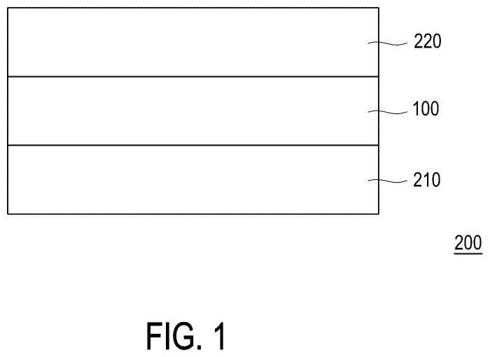

FIG. 1 is a block diagram of a display device according to an embodiment of the invention. Referring to FIG. 1, in the embodiment, a display device 200 includes a light source module 210, a display panel 220 and an electronically controlled viewing angle switching panel 100. In the embodiment, the electronically controlled viewing angle switching panel 100 is, for example, disposed between the display panel 220 and the light source module 210. In the embodiment, the display panel 220 is, for example, a liquid crystal display panel, a transmissive display panel, or a transflective display panel, but the invention is not limited thereto.

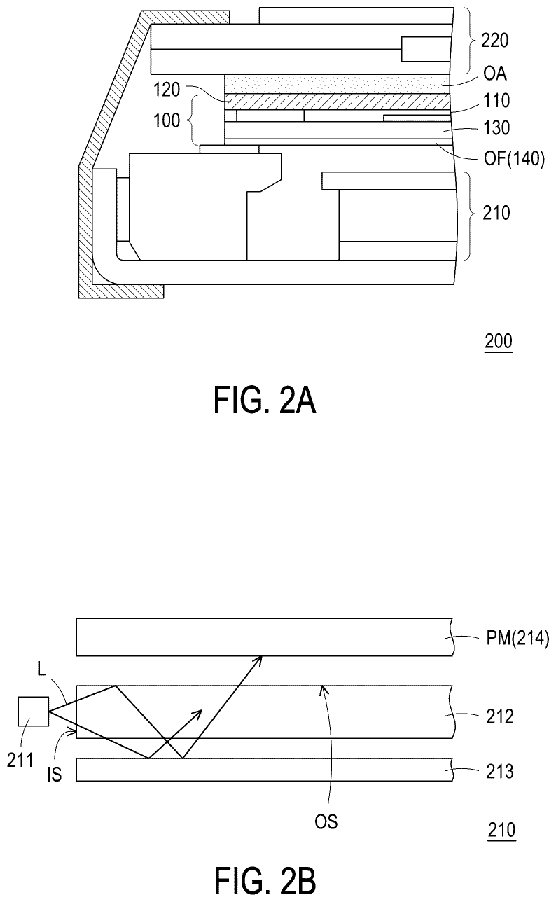

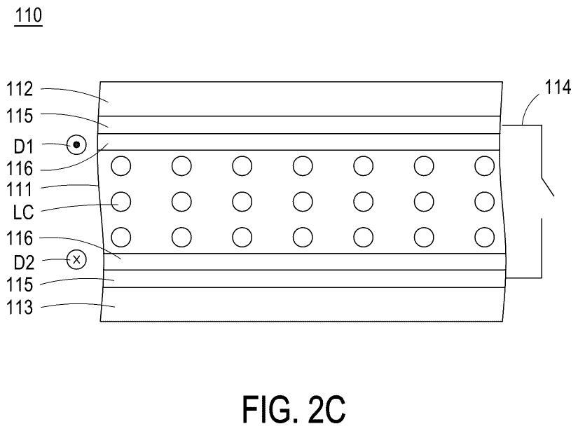

Various components in the display device 200 will be further described below with reference to FIG. 2A to FIG. 2C.

FIG. 2A is a schematic structural diagram of the display device 200 in FIG. 1. FIG. 2B is a schematic diagram of an optical path of the light source module 210 in FIG. 2A. FIG. 2C is a schematic structural diagram of a viewing angle adjustment element 110 in FIG. 2A. Referring to FIG. 2A and FIG. 2B, in the embodiment, the light source module 210 is configured to provide the light beams L to illuminate the display panel 220, and includes a light-emitting element 211, a light guide plate 212, a reflective element 213 and at least one optical film 214. The light-emitting element 211 is, for example, a strip light source including a plurality of point light sources, wherein the point light sources are, for example, light-emitting diodes (LEDs), but the invention is not limited thereto. The light-emitting element 211 may also be other types of strip light sources, such as a lamp tube, and the invention does not limit the type of the light source.

The light-emitting element 211 provides the light beams L. The light guide plate 212 is located on a transmission path of the light beams L. The reflective element 213 and the at least one optical film 214 are located on the transmission path of the light beams L, and the at least one optical film 214 is located between the light guide plate 212 and the electronically controlled viewing angle switching panel 100, the reflective element 213 is located on a side of the light guide plate 212 facing away the electronically controlled viewing angle switching panel 100.

Specifically, in the embodiment, the light-emitting element 211 is configured to provide the light beams L. The light guide plate 212, the reflective element 213 and the at least one optical film 214 are all located on the transmission path of the light beams L, and the light guide plate 212 has a light incident surface IS and a light output surface OS. The light beams L enter the light guide plate 212 from the light incident surface IS.

The reflective element 213 is disposed under the light guide plate 212 to reflect the light beams L emitted from a lower side of the light guide plate 212 back into the light guide plate 212 to improve light utilization efficiency.

Moreover, in the embodiment, as shown in FIG. 2A and FIG. 2B, the at least one optical film 214 is located between the light guide plate 212 and the electronically controlled viewing angle switching panel 100. For example, in the embodiment, the at least one optical film 214 is a prism sheet PM, which may be used to adjust a forward viewing angle of the light beams L emitted from the light output surface OS, but the invention is not limited thereto. In other embodiments, the light source module 210 may include other optical films disposed on the light guide plate 212. The optical films may be, for example, diffusers, prism sheets, louver films or combinations of the above elements, but the invention is not limited thereto. In addition, as shown in FIG. 2A and FIG. 2B, in the embodiment, the display panel 220, the electronically controlled viewing angle switching panel 100 are overlapped with the light output surface OS of the light guide plate 212, wherein the light source module 210 shown in FIG. 2A is a schematic structural diagram of the light source module 210 viewed from a side of the light guide plate 212 that is not adjacent to the light-emitting element 211. FIG. 2B is a schematic view of an optical path viewing around the side of the light guide plate 212 that is adjacent to the light-emitting element 211. As shown in FIG. 2B, the light beams L emit from the light output surface OS and then pass through the at least one optical film 214 and is transmitted to the electronically controlled viewing angle switching panel 100 and the display panel 220.

On the other hand, as shown in FIG. 2A, in the embodiment, the electronically controlled viewing angle switching panel 100 includes a viewing angle adjustment element 110, a first polarizer 120, a second polarizer 130 and a support structure 140. The viewing angle adjustment element 110 is located between the first polarizer 120 and the second polarizer 130. Moreover, as shown in FIG. 2A, in the embodiment, the electronically controlled viewing angle switching panel 100 is attached to the display panel 220 through optical colloid OA, and the optical colloid OA is located between the first polarizer 120 and the display panel 220. In this embodiment, the first polarizer 120 may also be used as a lower polarizer of the display panel 220, but the invention is not limited thereto. In another embodiment, the display panel 220 may has a lower polarizer, and the optical colloid OA is disposed between the lower polarizer and the first polarizer 120. On the other hand, the display panel 220 is configured with a third polarizer on a side away from the viewing angle adjustment element 110, which may be used as an upper polarizer of the display panel 220.

Further, as shown in FIG. 2C, in the embodiment, the viewing angle adjustment element 110 includes a liquid crystal layer 111, at least one plastic substrate 112, 113, a driving circuit 114 and two electrode layers 115. The liquid crystal layer 111 and the two electrode layers 115 are disposed between the plastic substrate 112 and the plastic substrate 113, and the liquid crystal layer 111 has a plurality of liquid crystal molecules LC and is disposed between the two electrode layers 115. The driving circuit 114 is connected to the two electrode layers 115, and is configured to provide a voltage to the two electrode layers 115. In addition, the viewing angle adjustment element 110 further includes at least one alignment layer 116. The at least one alignment layer 116 may be, for example, two alignment layers 116, which are respectively disposed between the liquid crystal layer 111 and the two electrode layers 115, where one of the alignment layers 116 has an alignment direction D1, and the other alignment layer 116 has an alignment direction D2, where the alignment direction D1 and the alignment direction D2 are, for example, anti-parallel. The two alignment layers 116 are configured to align the liquid crystal molecules LC, where an absorption axis of the second polarizer 130 is substantially perpendicular to the alignment direction D1. In the embodiment, the electrode layer 115 may be made of a transparent conductive electrode material (such as ITO, IZO or ITZO). The two alignment layers may be, for example, made of polyimide (PI), and may be made through a brush alignment process or photo alignment process. The liquid crystal layer 111 may include, for example, twisted nematic (TN), in-plane switching (IPS) or other type liquid crystal.

Furthermore, when the driving circuit 114 is not powered, there is no potential difference between the two electrode layers 115, and the plurality of liquid crystal molecules LC are arranged along the alignment directions of the two alignment layers, when the liquid crystal molecules LC do not be driven by an external electric field. The light beams L (polarized light) passing through the second polarizer 130 at various angles do not change the polarization direction after passing through the viewing angle adjustment element 110, and therefore do not affect the viewing angle. When the driving circuit 114 is powered on, a potential difference is generated between the two electrode layers 115, and the electric field may drive the plurality of liquid crystal molecules LC of the liquid crystal layer 111 to rotate (not shown in the figure). For example, long axes of most of the liquid crystal molecules LC are turned to be perpendicular to the plastic substrate 112. In this way, in the direction perpendicular to the alignment direction D1 (i.e., a viewing angle control direction), the light beam L incident to the viewing angle adjustment element 110 at a larger angle may be converted into a different polarization direction after passing through the liquid crystal layer 111, while the light beam L incident to the viewing angle adjustment element 110 at a small angle will not change the polarization direction after passing through the liquid crystal layer 111. Finally, the light beams L incident to the display panel 220 at smaller angles may pass through the first polarizer 120 smoothly, while the light beams L incident to the display panel 220 at larger angles may be absorbed by the first polarizer 120 (an absorption axis of the first polarizer 120 is, for example, parallel to the absorption axis of the second polarizer 130). Thereby, the effect of viewing angle control is achieved.

Moreover, in the embodiment, the support structure 140 is connected to at least a part of the second polarizer 130, and may be used to strengthen the structure of the second polarizer 130 or transmit stress, so as to suppress its shrinkage and deformation. As shown in FIG. 2A, in the embodiment, the support structure 140 is an optical film OF, where the second polarizer 130 is located between the viewing angle adjustment element 110 and the optical film OF, and the optical film OF is attached to the second polarizer 130.

In the embodiment, a thickness of the optical film OF ranges, for example, from 110 μm to 310 μm, and a material of the optical film OF may be polyethylene terephthalate (PET), where the PET has high strength and excellent mechanical properties, such as high rigidity and hardness, extremely low water absorption, good chemical resistance, especially acid resistance, and good transparency and gloss.

In this way, because of the mechanical properties of the optical film OF, the strength of the second polarizer 130 may be reinforced to effectively suppress the shrinkage of the second polarizer 130 under reliability test conditions of high temperature, high humidity and/or thermal shock, thereby prevent deformation of the electronically controlled viewing angle switching panel 100, maintain flatness and structural integrity of the components, and ensure the reliability of the electronically controlled viewing angle switching panel 100 and the display device 200. The risk of reliability problems is reduced and the display quality of the display device 200 is not affected by the reliability test.

For example, in the embodiment, the optical film OF serving as the support structure 140 may be a louver film or a light turning film, and may be used to change a light shape of the light source module 210, improve the brightness, improve the image uniformity and/or change the viewing angle of the light beams L provided by the light source module 210 at the same time, but the invention is not limited thereto. Specifically, the optical films qualified to be used as the optical film OF in the invention has the mechanical properties that the film surface thereof would not deform or wrinkle in the high temperature and/or high humidity (70° C./90%, 1000 Hr) environment, and the display quality of the display device 200 having the optical film would not be affected by the reliability test after the display device 200 goes through the reliability test of the final product.

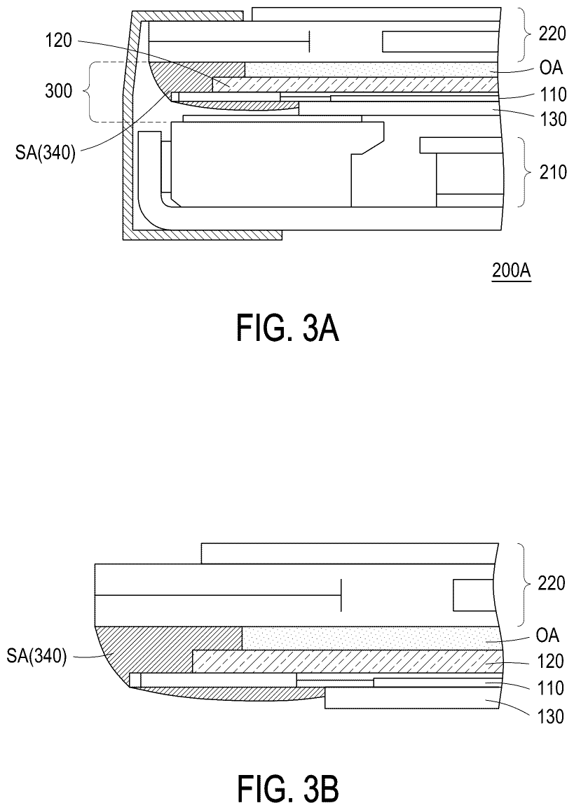

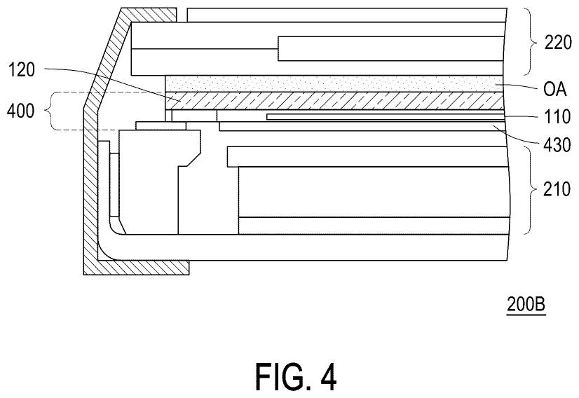

In addition, in the aforementioned embodiment, although the optical film OF with good mechanical properties is used as an example of the support structure 140, the invention is not limited thereto. In other embodiments, the support structure 140 may also be other structures used to reinforce structure or transmit stress, and inhibit shrinkage and deformation of the polarizer, thereby enable the electronically controlled viewing angle switching panel 100 and the display device 200 to achieve the aforementioned effects and advantages. Further description will be given below with reference to FIG. 3A to FIG. 4.

FIG. 3A is a schematic structural diagram of a display device according to another embodiment of the invention. FIG. 3B is an enlarged schematic diagram of a partial area of FIG. 3A. Referring to FIG. 3A and FIG. 3B, the electronically controlled viewing angle switching panel 300 and a display device 200A of the embodiment are similar to the electronically controlled viewing angle switching panel 100 and the display device 200 in FIG. 2A, and differences there between are as follows. As shown in FIG. 3A and FIG. 3B, in the embodiment, a support structure 340 of the electronically controlled viewing angle switching panel 300 is a support colloid SA, which at least covers and adheres a side surface of the viewing angle adjustment element 110, a side surface of the first polarizer 120, a side surface of the second polarizer 130 and a part of a surface of the display panel 220 adjacent to the electronically controlled viewing angle switching panel 300 and not covered by the electronically controlled viewing angle switching panel 300.

Furthermore, in the embodiment, the display panel 220 has a thickness of at least 0.05 mm and is rigid. Since the support colloid SA is used to connect the display panel 220 and cover the electronically controlled viewing angle switching panel 300, the electronically controlled viewing angle switching panel 300 may strengthen its own structure by the support colloid SA and the stress may be transmitted to the display panel 220. Stiffness of the electronically controlled viewing angle switching panel 300 may be further enhanced through the rigidity of the display panel 220 to avoid deformation.

In this way, because of the support colloid SA, the strength of the first polarizer 120 and the second polarizer 130 of the electronically controlled viewing angle switching panel 300 may be reinforced to effectively suppress shrinkage of the first polarizer 120 and the second polarizer 130 under reliability test conditions of high temperature, high humidity or thermal shock, so as to prevent deformation of the electronically controlled viewing angle switching panel 300, ensure the reliability of the electronically controlled viewing angle switching panel 300 and the display device 200A, reduce the risk of reliability problems, and ensure that the display quality of the display device 200A will not be affected by the reliability test.

In the embodiment, a material of the support colloid SA is, for example, silicone rubber having the main constituent of silicone, which belongs to the room temperature vulcanization (RTV) and is suitable for environment with working temperature from −50° C. to 200° C. Silicone rubber has good adhesion property, its colloid nature is non-toxic, non-polluting, non-corrosive, good at electrical insulation and arc resistance, aging resistance, moisture-proof, shock-proof, etc., and may be used for structural protection or reinforcement of structures, but the invention is not limited thereof. In other embodiments, as long as the material may be used for structural reinforcement and weather fastness thereof may meet the requirements of reliability test, it may be used as the material of the support colloid SA.

FIG. 4 is a schematic structural diagram of a display device according to another embodiment of the invention. Referring to FIG. 4, an electronically controlled viewing angle switching panel 400 and a display device 200B of the embodiment are similar to the electronically controlled viewing angle switching panel 100 and the display device 200 in FIG. 2A, and differences there between are as follows. In the embodiment, the second polarizer 430 is a coating type polarizer. The coating type polarizer is made of liquid crystal materials and dyes. The coating type polarizer does not contain polyvinyl alcohol (PVA), and the drawing process is not needed. Therefore, the coating type polarizer has low internal stress and is not prone to shrinkage and deformation in the high temperature and high humidity environment.

More specifically, in the embodiment, the material of the coating type polarizer, i.e., the liquid crystal materials and the dyes, may be directly coated on the plastic substrate of the electronically controlled viewing angle switching panel 400 facing the light source module 210, and then a surface hardening treatment technology is adopted to protect the material of the coating type polarizer. In this way, the overall structure may be further thinned.

Alternatively, in the embodiment, the second polarizer 430 may include a low complex refractive index substrate or a substrate made of polyethylene terephthalate. The material of the coating type polarizer, i.e., the liquid crystal materials and dyes may be coated on the low complex refractive index substrate or the substrate, so as to form the coating type polarizer on the low complex refractive index substrate or the substrate. In the embodiment, when the substrate is made of polyethylene terephthalate, an optical axis of the substrate should be perpendicular to or parallel to the absorption axis of the coating type polarizer, or should be within a range of ±30 degrees from the absorption axis of the coating type polarizer.

In this way, the low complex refractive index substrate or the substrate may be used as a protective layer and support of the coating type polarizer, and the coating type polarizer formed thereon may be bonded to the plastic substrate of the electronically controlled viewing angle switching panel 400 facing the light source module 210 through the optical colloid OA, so as to form the second polarizer 430.

In this way, through the configuration of the coating type polarizer, the second polarizer 430 is not easy to shrink and deform under reliability test conditions of high temperature and high humidity or thermal shock, thereby prevents deformation of the electronically controlled viewing angle switching panel 400, ensures the reliability of the electronically controlled viewing angle switching panel 400 and the display device 200B, so as to reduce the risk of reliability problems and ensure that the display quality of the display device 200B will not be affected by the reliability test. In addition, when the second polarizer 430 includes the low complex refractive index substrate or the substrate, the low complex refractive index substrate or the substrate may also be used as a protective layer and support for the coating type polarizer, and the electronically controlled viewing angle switching panel 400 and the display device 200B may achieve the aforementioned effects and advantages.

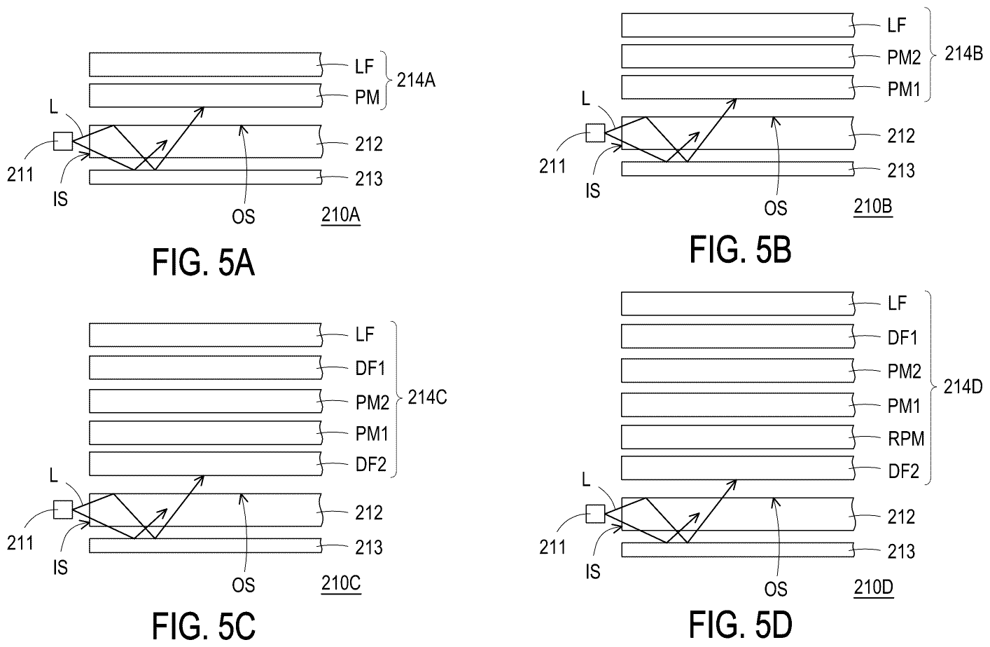

In addition, in the aforementioned embodiments, although the at least one optical film 214 is exemplified by the prism sheet PM, the invention is not limited thereto. In other embodiments, the at least one optical film 214 may also be a diffusion sheet, a prism sheet, a louver film, or a combination of the above elements, and the display device 200 may also achieve the aforementioned functions and achieve the aforementioned effects and advantages. Further descriptions will be provided below with reference to FIG. 5A and FIG. 5D.

FIG. 5A to FIG. 5D are schematic structural diagrams of various light source modules in FIG. 1. Referring to FIG. 5A to FIG. 5D, light source modules 210A, 210B, 210C, and 210D of the embodiment of FIG. 5A to FIG. 5D are similar to the light source module 210 of FIG. 2A, and differences there between are as follows.

In the embodiment of FIG. 5A, besides the prism sheet PM, at least one optical film 214A of the light source module 210A further includes a louver film LF.

In the embodiment of FIG. 5B, at least one optical film 214B of the light source module 210B includes a first prism sheet PM1, a second prism sheet PM2 and a louver film LF, wherein the first prism sheet PM1 and the second prism sheet PM2 are located between the light guide plate 212 and the louver film LF, and the first prism sheet PM1 is located between the second prism sheet PM2 and the light guide plate 212.

In the embodiment of FIG. 5C, at least one optical film 214C of the light source module 210C includes a first diffusion sheet DF1, a first prism sheet PM1, a second prism sheet PM2, a second diffusion sheet DF2 and a louver film LF, wherein the first diffusion sheet DF1, the second diffusion sheet DF2, the first prism sheet PM1 and the second prism sheet PM2 are located between the light guide plate 212 and the louver film LF, and the first prism sheet PM1 and the second prism sheet PM2 are located between the first diffusion sheet DF1 and the second diffusion sheet DF2.

In the embodiment of FIG. 5D, at least one optical film 214D of the light source module 210D includes a first diffusion sheet DF1, a second diffusion sheet DF2, a first prism sheet PM1, a second prism sheet PM2, a reverse prism sheet RPM, and a louver film LF, where the first diffusion sheet DF1, the second diffusion sheet DF2, the first prism sheet PM1, the second prism sheet PM2 and the reverse prism sheet RPM are located between the light guide plate 212 and the louver film LF; the first prism sheet PM1 and the second prism sheet PM2 are located between the first diffusion sheet DF1 and the second diffusion sheet DF2, and the reverse prism sheet RPM is located between the first diffusion sheet DF1 and the first prism sheet PM1.

In the above embodiments, since the light source modules 210A, 210B, 210C, and 210D may all provide the light beam L to illuminate the display panel 220, they may also be applied to the display devices 200, 200A, and 200B of FIG. 2A to FIG. 4 to replace the light source module 210, and when the light source modules 210A, 210B, 210C, and 210D are applied to the display devices 200, 200A, and 200B of FIG. 2A to FIG. 4, the display devices 200, 200A, and 200B may also achieve the aforementioned functions, and may achieve the aforementioned effects and advantages, and details thereof are not repeated.

In summary, in the electronically controlled viewing angle switching panel and the display device according to an embodiment of the invention, through the arrangement of the support structure, shrinkage of the polarizer may be effectively suppressed under reliability test conditions of high temperature, high humidity and/or thermal shock, which thereby prevents deformation of the electronically controlled viewing angle switching panel, and maintains flatness and structural integrity of the components, and thus ensures the reliability of the electronically controlled viewing angle switching panel and the display device, so as to reduce the risk of reliability problems.

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items.

Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

What is claimed is:

1. An electronically controlled viewing angle switching panel, comprising:
a viewing angle adjustment element, comprising at least one plastic substrate;
a first polarizer;
a second polarizer, wherein the viewing angle adjustment element is located between the first polarizer and the second polarizer; and
a support structure, connected to at least a part of the second polarizer.

2. The electronically controlled viewing angle switching panel according to claim 1, wherein the support structure is an optical film, wherein the second polarizer is located between the viewing angle adjustment element and the optical film, and the optical film is attached to the second polarizer.

3. The electronically controlled viewing angle switching panel according to claim 2, wherein a thickness of the optical film ranges from 110 μm to 310 μm.

4. The electronically controlled viewing angle switching panel according to claim 2, wherein a material of the optical film is polyethylene terephthalate.

5. The electronically controlled viewing angle switching panel according to claim 1, wherein the support structure is a support colloid covering at least a side surface of the viewing angle adjustment element, a side surface of the first polarizer and a side surface of the second polarizer.

6. The electronically controlled viewing angle switching panel according to claim 5, wherein a material of the support colloid is silicone rubber.

7. The electronically controlled viewing angle switching panel according to claim 1, wherein the second polarizer is a coating type polarizer.

8. The electronically controlled viewing angle switching panel according to claim 7, wherein the second polarizer further comprises a low complex refractive index substrate, and a material of the coating type polarizer is coated on the low complex refractive index substrate.

9. The electronically controlled viewing angle switching panel according to claim 7, wherein the second polarizer comprises a substrate, a material of the substrate is polyethylene terephthalate, and a material of the coating type polarizer is coated on the substrate.

10. A display device, comprising:
a light source module,
a display panel; and
an electronically controlled viewing angle switching panel, located between the light source module and the display panel, and comprising:
a viewing angle adjustment element, comprising at least one plastic substrate;
a first polarizer;
a second polarizer, wherein the viewing angle adjustment element is located between the first polarizer and the second polarizer; and
a support structure, connected to the second polarizer.

11. The display device according to claim 10, wherein the support structure is an optical film, wherein the second polarizer is located between the viewing angle adjustment element and the optical film, and the optical film is attached to the second polarizer.

12. The display device according to claim 11, wherein a thickness of the optical film ranges from 110 μm to 310 μm.

13. The display device according to claim 11, wherein a material of the optical film is polyethylene terephthalate.

14. The display device according to claim 10, wherein the support structure is a support colloid at least covering a side surface of the viewing angle adjustment element, a side surface of the first polarizer and a side surface of the second polarizer, and a part of a surface of the display panel adjacent to the electronically controlled viewing angle switching panel and not covered by the electronically controlled viewing angle switching panel.

15. The display device according to claim 14, wherein a material of the support colloid is silicone rubber.

16. The display device according to claim 10, wherein the second polarizer is a coating type polarizer.

17. The display device according to claim 16, wherein the second polarizer further comprises a low complex refractive index substrate, and a material of the coating type polarizer is coated on the low complex refractive index substrate.

18. The display device according to claim 16, wherein the second polarizer comprises a substrate, a material of the substrate is polyethylene terephthalate, and a material of the coating type polarizer is coated on the substrate.

19. The display device according to claim 10, wherein the electronically controlled viewing angle switching panel is attached to the display panel through an optical colloid, and the optical colloid is located between the first polarizer and the display panel.

20. The display device according to claim 10, wherein the light source module comprises:
a light-emitting element, providing a light beam;
a light guide plate, located on a transmission path of the light beam; and
a reflective element, located on a transmission path of the light beam.

21. The display device according to claim 20, wherein the light source module further comprises:
at least one optical film, wherein the at least one optical film is located on the transmission path of the light beam, and located between the light guide plate and the electronically controlled viewing angle switching panel.
